(19) United States
(12) Patent Application Publication
(10) Pub. No.: US 2020/0106602 A1
(43) Pub. Date: Apr. 2, 2020

(54) BLOCKCHAIN SYSTEM HAVING MULTIPLE PARITY LEVELS AND MULTIPLE LAYERS FOR IMPROVED DATA SECURITY

(71) Applicant: ViVi Holdings, Inc., Boca Raton, FL (US)

(72) Inventors: Lucas Avelino Sodre Santos, Sao Paulo (BR); Lupercio Amaral Junior, Tamarac, FL (US); Stephen Thomas Harkey, Boyton Beach, FL (US)

(21) Appl. No.: 16/589,946

(22) Filed: Oct. 1, 2019

Related U.S. Application Data
(60) Provisional application No. 62/740,153, filed on Oct. 2, 2018.

(51) Int. Cl. H04L 9/06; H04L 9/08

(52) U.S. Cl. CPC H04L 9/0637; H04L 9/0872; H04L 2209/38; H04L 9/0825; H04L 9/088; H04L 9/0866

(57) ABSTRACT

A blockchain system shared by a plurality of computing nodes includes a first blockchain subdivided into a first blockchain first layer and a first blockchain second layer and a second blockchain subdivided into a second blockchain first layer and a second blockchain second layer. The blockchain system stores an input dataset that is divided into a plurality of input dataset pieces that are stored on at least one of the first blockchain second layer and second blockchain second layer. The input dataset pieces are assigned an address reporting their respective location in the blockchain system. The blockchain system may be used to store personal identification information and may be used in identity verification.

### CROSS-REFERENCE TO RELATED APPLICATION

This claims the benefit of priority from provisional Application No. 62/740,153, filed Oct. 2, 2019, the entire contents of which are incorporated by reference herein.

### FIELD

This relates to the field of computing and, more particularly, improving data security using a new blockchain architecture

### BACKGROUND

A blockchain is a data storage mechanism that is resistant to hacking and modification. It is typically used to record transactions between different parties because entries are permanent and verifiable. Once data gets recorded to a blockchain, the data on any given block cannot be modified without also modifying other subsequent blocks.

A blockchain system is decentralized across different interconnected nodes, which are typically individual computers. Blockchain functions are often carried out by each node rather than by a single centralized server. This increases speed and security. If one node in the blockchain fails, the blockchain data remain safe because the data are stored across the blockchain on other nodes. Although traditional blockchain systems are more secure than centralized servers, hackers have recently found ways to hack them. This puts the data on the blockchain at risk of public exposure.

### BRIEF SUMMARY

The improved blockchain system described here provides enhanced data security compared to traditional blockchains. The blockchain described here distributes datasets over a plurality of parity levels and layers.

An example of a computer-based method comprises accessing, by a processor, a blockchain system shared by a plurality of computing nodes. The blockchain system includes (i) a first blockchain subdivided into a first blockchain first layer and a first blockchain second layer and (ii) a second blockchain subdivided into a second blockchain first layer and a second blockchain second layer. The blockchain system stores an input dataset that is divided into a plurality of input dataset pieces that are stored on at least one of the first blockchain second layer and second blockchain second layer. The input dataset pieces are assigned an address reporting their respective location in the blockchain system. The method also includes receiving a request from a computing device with a security key to access the input dataset, searching the blockchain system for the addresses of the input dataset pieces, merging the input dataset pieces into a merged file representative of the input dataset, and making available the merged file to the access computing device.

Additional examples of the method may include one or more of the following features

The blockchain system may execute a dividing module that divides the input dataset into the input dataset pieces, the dividing module being stored on at least one of the first blockchain first layer and second blockchain first layer.

The blockchain system may execute an address assignment module that assigns the address, the address assignment module being stored on at least one of the first blockchain first layer and second blockchain first layer.

The first blockchain first layer and the second blockchain first layer may store the respective addresses of the input dataset pieces.

The input dataset may include personal identification information of a person and the method may further comprise verifying the person's identity by receiving from a computing device a test data file and comparing the merged file to the test data file with an analysis module executed by the blockchain system.

The personal identification information may include at least one of a facial image, a voice recording, and a geographic location of the person.

The input dataset pieces stored on the first blockchain may not be stored on the second blockchain.

The first blockchain second layer and the second blockchain second layer may be configured, respectively, to restore the first blockchain first layer and the second blockchain first layer when data in the first blockchain first layer and/or the second blockchain first layer become corrupted.

The security key may be at least one of a parity permission security key that permits access to both the first blockchain and second blockchain and a layer permission security key that permits access to only one of the first blockchain and second blockchain.

The blockchain system may include additional blockchains having one or more layers.

An example of a computer-based system comprises a computer readable memory storage medium storing a blockchain system and at least one processor in communication with the memory storage medium. The processor is configured to execute program instructions to access by a processor, a blockchain system shared by a plurality of computing nodes. The blockchain system includes (i) a first blockchain subdivided into a first blockchain first layer and a first blockchain second layer and (ii) a second blockchain subdivided into a second blockchain first layer and a second blockchain second layer. The blockchain system stores an input dataset that is divided into a plurality of input dataset pieces that are stored on at least one of the first blockchain second layer and second blockchain second layer. The input dataset pieces are assigned an address reporting their respective location in the blockchain system. The process is also configured to execute program instructions to receive a request from a computing device with a security key to access the input dataset, search the blockchain system for the addresses of the input dataset pieces, merge the input dataset pieces into a merged file representative of the input dataset, and make available the merged file to the access computing device.

Additional examples of the system may include one or more of the following features.

The processor may also execute dividing module that divides the input dataset into the input dataset pieces, the dividing module being stored on at least one of the first blockchain first layer and second blockchain first layer.

The processor may also execute an address assignment module that assigns the address, the address assignment module being stored on at least one of the first blockchain first layer and second blockchain first layer.

The first blockchain first layer and the second blockchain first layer may store the respective addresses of the input dataset pieces.

The input dataset may include personal identification information of a person and the processor may further execute program instructions to verify the person's identity by receiving from a computing device a test data file and comparing the merged file to the test data file with an analysis module executed by the blockchain system.

The personal identification information may include at least one of a facial image, a voice recording, and a geographic location of the person.

The input dataset pieces stored on the first blockchain may not be stored on the second blockchain.

The first blockchain second layer and the second blockchain second layer may be configured, respectively, to restore the first blockchain first layer and the second blockchain first layer when data in the first blockchain first layer and/or the second blockchain first layer become corrupted.

The security key may be at least one of a parity permission security key that permits access to both the first blockchain and second blockchain and a layer permission security key that permits access to only one of the first blockchain and second blockchain.

The blockchain system may include additional blockchains having one or more layers.

An example of a computer-based product comprises a computer readable memory storage medium storing a blockchain system and at least one processor in communication with the memory storage medium. The processor is configured to execute program instructions to access by a processor, a blockchain system shared by a plurality of computing nodes. The blockchain system includes (i) a first blockchain subdivided into a first blockchain first layer and a first blockchain second layer and (ii) a second blockchain subdivided into a second blockchain first layer and a second blockchain second layer. The blockchain system stores an input dataset that is divided into a plurality of input dataset pieces that are stored on at least one of the first blockchain second layer and second blockchain second layer. The input dataset pieces are assigned an address reporting their respective location in the blockchain system. The process is also configured to execute program instructions to receive a request from a computing device with a security key to access the input dataset, search the blockchain system for the addresses of the input dataset pieces, merge the input dataset pieces into a merged file representative of the input dataset, and make available the merged file to the access computing device.

Additional examples of the system may include one or more of the following features.

The processor may also execute a dividing module that divides the input dataset into the input dataset pieces, the dividing module being stored on at least one of the first blockchain first layer and second blockchain first layer.

The processor may also execute an address assignment module that assigns the address, the address assignment module being stored on at least one of the first blockchain first layer and second blockchain first layer.

The first blockchain first layer and the second blockchain first layer may store the respective addresses of the input dataset pieces.

The input dataset may include personal identification information of a person and the processor may further execute program instructions to verify the person's identity by receiving from a computing device a test data file and comparing the merged file to the test data file with an analysis module executed by the blockchain system.

The personal identification information may include at least one of a facial image, a voice recording, and a geographic location of the person.

The input dataset pieces stored on the first blockchain may not be stored on the second blockchain.

The first blockchain second layer and the second blockchain second layer may be configured, respectively, to restore the first blockchain first layer and the second blockchain first layer when data in the first blockchain first layer and/or the second blockchain first layer become corrupted.

The security key may be at least one of a parity permission security key that permits access to both the first blockchain and second blockchain and a layer permission security key that permits access to only one of the first blockchain and second blockchain.

The blockchain system may include additional blockchains having one or more layers.

### BRIEF DESCRIPTION OF THE DRAWINGS

FIG. 1 is a block diagram of aspects of an example of the blockchain system.

FIG. 2 is a block diagram of an example of a computing device.

FIG. 3 is a block diagram of an example of the blockchain architecture.

FIG. 4 is a block diagram illustrating certain functions of the input module.

FIG. 5 is a block diagram illustrating certain functions of the dividing module.

FIG. 6 is a block diagram illustrating certain functions of the address assignment module.

FIG. 7 is a block diagram illustrating how a single parity level blockchain with two layers may store an input dataset

FIG. 8 is a block diagram illustrating how a two parity level blockchain with two layers may store an input dataset.

FIG. 9 is a block diagram illustrating the storage of personal identification information as an input dataset.

FIG. 10 is a flow chart illustrating the conversion of different types of input datasets into an encrypted file.

FIG. 11 is a block diagram illustrating certain functions of the security key generator.

FIG. 12 is a flow chart illustrating how a merged data file may be accessed.

FIG. 13 is an example of code that may be used to retrieve a merged data file.

FIG. 14 is a block diagram illustrating certain functions of the analysis module.

### DETAILED DESCRIPTION OF EXAMPLE EMBODIMENTS

This disclosure describes exemplary embodiments, but not all possible embodiments of the system, method, and product. Where a particular feature is disclosed in the context of a particular example, that feature can also be used, to the extent possible, in combination with and/or in the context of other examples. The system, method, and product may be embodied in many different forms and should not be construed as limited to only the examples described here.

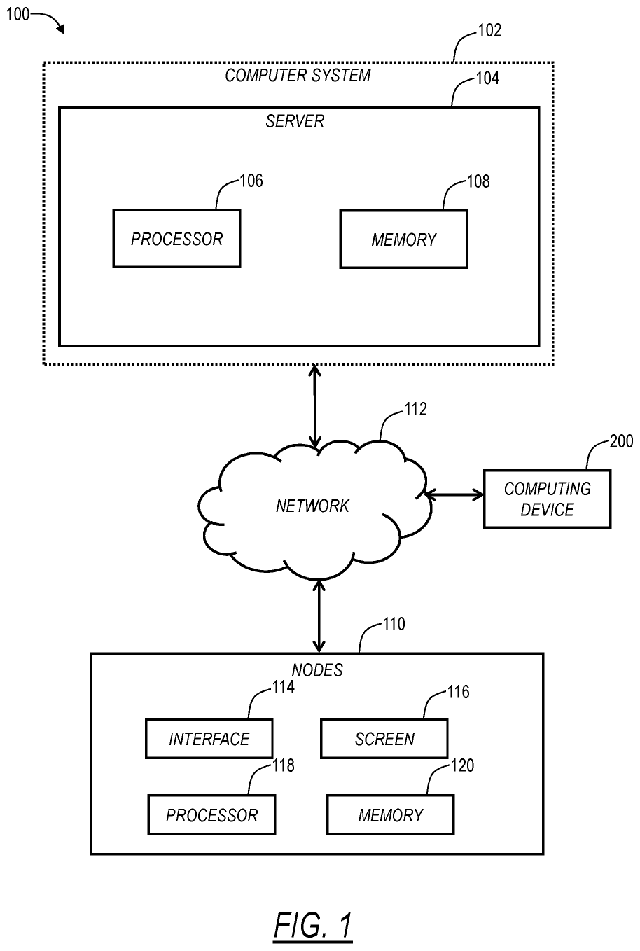

Referring to FIG. 1, the blockchain system 100 includes a computer system 102 with a server 104 having at least one processor 106 and non-transitory machine readable memory 108 storing program instructions. The processor 106 executes computer program instructions to operate functions of the blockchain system 100. The computer system 102 communicates with a plurality of nodes 110 through a network 112, such as the Internet. The network 112 may be a public network or a private network.

The computer system 102 is not limited to any particular number, type, or configuration of processors 106, nor to any particular programming language, memory storage format or memory storage medium 108. The computer system 102 may include multiple processors 106 and/or machine readable memory 108 storage media.

The computer system 102 is not necessarily limited to any particular language, geographic location, or networking or connection of the processors 106 and/or machine readable memory 108 storage media, provided that the processors 106 and/or machine readable memory 108 storage media are able to cooperate to execute the disclosed functions. Further, it is not necessarily required for the processors 106 and/or machine readable memory 108 storage media to be commonly owned or controlled.

The nodes 110 are a plurality of computing devices configured to store the blockchain thereon and communicate with each other and the computer system 102 via the network 112. The nodes 110 can execute an interface 114 that may take the form of a website, an application program interface (API), a graphical user interface, or the like. The interface 114 may be displayed on a screen 116 of the computing device. The nodes 110 further include a processor 118 and a memory 120. The memory 120 stores the blockchain thereon and program instructions that the processor 118 executes. Examples of nodes include, but are not limited to, desktop computers, laptop computers, tablets, mobile devices, and mobile phones such as smart phones, and the like.

One or more computing devices 200 may be used to communicate with the system 100 via the network 112. Such computing devices 200 may be operated by users who wish to input data into the system 100 or retrieve data from the system 100.

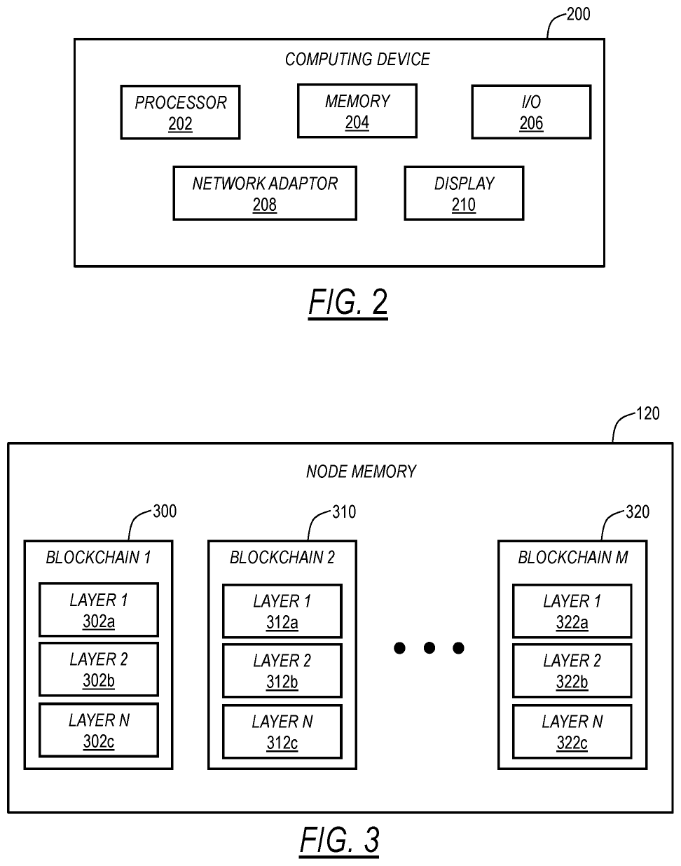

Referring now to FIG. 2, an example of a computing device 200 that may be used to communicate with the system 100 is now described. The computing device 200 includes a processor 202, memory 204, an I/O interface 206, a network adaptor 208, and a display 210. These features may communicate with each other through a bus or wirelessly and may be located within in a single device or be divided across multiple devices.

An example of the processor 202 is a computer microprocessor such as one that includes one or more processing units such as a central processing unit (CPU) and a graphical processing unit (GPU), The computing device 200 may include one or more of the processors 202, In some cases, one or more of the processors 202 may be accessed remotely relative to one or more of the other processor(s) 202. Processors 118 and 106 may also be similar.

An example of the memory 204 includes non-transitory memory containing non-transitory program instructions. Examples of such memory 204 include a random access memory (RAM), a hard disk, a removable storage device, or remote memory such as cloud storage.

The memory 204 stores data and executable program instructions, such as software programs, for performing various computing functions. The processor 202 is capable of executing the program instructions stored on memory 204 to cause the computing device 200 to perform computing operations consistent of the systems and methods disclosed herein. The processors 106 and 118 and memory 108 and 120 may be similar.

An example of the I/O interface 206 includes hardware and software for communication with the computing device 200 by a user. The I/O interface 206 may include, for example, a keyboard, mouse, touch screen, camera, microphone, speaker, and the like.

An example of the network adapter 208 includes and software for allowing the computing device 200 to communicate information over the network 112 information. Examples of the network adapter 208 may include, for example, a local area network (LAN) adapter, a wireless wide area network (WWAN) adapter, a Bluetooth® module, a near field communication adapter, or the like.

An example of the display 210 is a device that provides a visible output to a user such as, for example, a computer screen, an LCD screen, or the like.

It is to be understood that the nodes 110 may include the features of a computing device 200.

Referring to FIG. 3, the new blockchain architecture is stored in the nodes' memory 120. The blockchain is advantageously configured to store pieces of a complete dataset across different locations in the blockchain for better data security than conventional blockchains.

The blockchain architecture includes a first blockchain 300 subdivided into a first blockchain first layer 302a, a first blockchain second layer 302b, and may include up to N first blockchain layers 302c. The blockchain system architecture further includes a second blockchain 310 subdivided into a second blockchain first layer 312a, a second blockchain second layer 312b, and may include up to N second blockchain layers 312c. The blockchain architecture may include up to M number of blockchains 320, each having up to N sublayers 322a, 322b, 322c. Here, M and N are integers, which may or may not be the same. Each blockchain 300, 310, 320 is a fully functional blockchain database. As used herein each blockchain 300, 310, 320 is referred to as a parity level, which is represented by M.

In order for the processor 106 to execute the blockchain system, the nodes 110 store the blockchain architecture of FIG. 3 on their respective memory 120. This redundancy provides a high level of security because the blockchain does not have to be centrally stored and administered by a single entity. The layers can help the main blockchain recover from an attack of 51% power by rebuilding the main blockchain index if they detect that there was change.

The parity level M functions as the first part of the blockchain address where pieces of data from an input dataset are stored. With just 1 parity level (M=1), the sub-layer blockchains may include the same data. In a multi-parity blockchain system (M>1) the data pieces are stored in several parity levels. For example, in a 2-parity blockchain (M=2), a data piece may be stored in parity level 1 or level 2 but not in both. This permits the data pieces to be physically stored closer to the locations that are going to use it, but not excluding the possibility of storing the data pieces at locations far away from the locations that are going to use it.

The nodes 110 execute various program modules via the processor 118 and memory 120. Such program modules are stored on the memory 120. Examples of several of these program modules are now described.

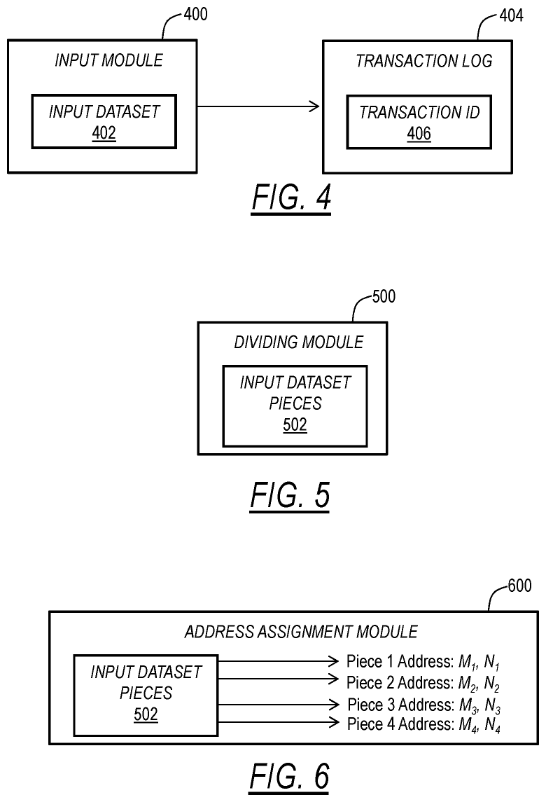

Referring to FIG. 4, an input module 400 includes program instructions for receiving a new dataset into nodes 110. The input module 400 is in communication with a computing device 200 from which the dataset is input and communicated to the nodes 110 via the network 112. The dataset the input module receives is referred to herein as an input dataset 402. The input dataset 402 is a substantially complete representation of the dataset input into the computing device 200.

The processor 118 executes instructions stored on the memory 120 to create a transaction log 404, which is stored on the memory 120 and logs activities for a particular transaction. Each transaction in the transaction log 404 has a transaction identification 406 that permits the nodes 110 to identify each transaction and associate input datasets 402 with a particular transaction. In certain preferred examples, the transaction log 404 does not store sensitive data that is otherwise secured on the blockchain.

Referring to FIG. 5, a dividing module 500 divides the input dataset 402 into a plurality of input dataset pieces 502 that, when re-combined, form the input dataset 402. Using the N-layer M-parity blockchain, the input dataset 402 can be divided into as many input dataset pieces 502 the user desires. The input dataset pieces 502 can then be stored within different layers and/or parity levels of the blockchain.

Referring to FIG. 6, an address assignment module 600, which is stored on Layer 1 of a blockchain in the blockchain assigns an address within the blockchain to the input dataset pieces 502 such that each input dataset piece 502 has a different address within the blockchain. Each address may be represented by the M and N values for where a particular input dataset piece 502 is located. This function distributes pieces of the original input dataset 402 across different locations in the blockchain for extra data security.

FIG. 6 illustrates an example in which the dividing module 500 divides the input dataset 402 into four input dataset pieces 502. The address assignment module 600 assigns an address to each of the four input dataset piece 502. The blockchain system 100 stores these addresses in Layer 1 of the a given blockchain, allowing Layer 1 to function as a secure storage location for input dataset piece 502 addresses in subsequent layers (Layers 2, 3, 4, etc.) Layer 1 also stores the transaction identification 406 associated with the input dataset 402 so that Layer 1 knows where the input data set pieces 502 for a given transaction are located in the blockchain.

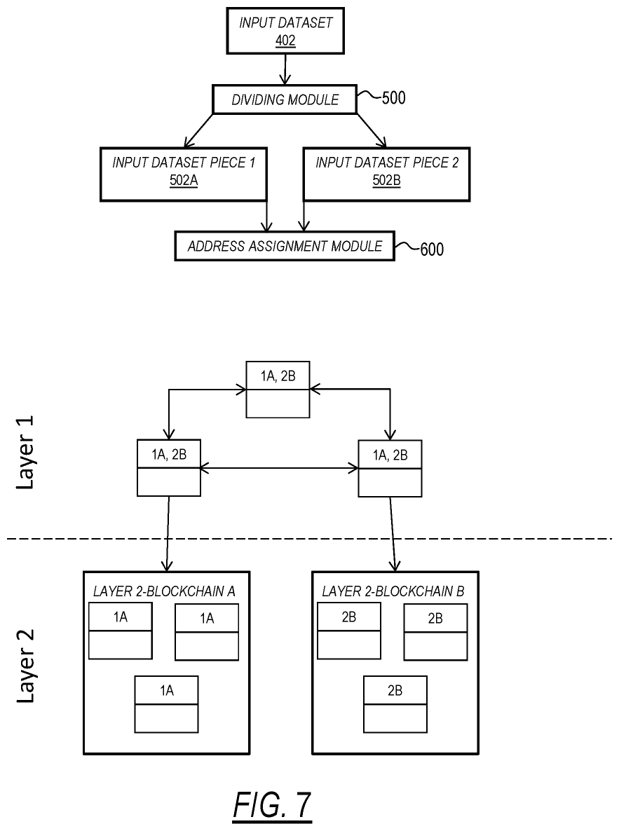

FIG. 7 is a block diagram that helps illustrate certain functions of the dividing module 500 and address assignment module 600 when the blockchain is a single parity level (M=1) blockchain with two layers (N=2). Layer 2 of the blockchain includes two sub-blockchains, namely Layer 2-Blockchain A and Layer 2-Blockchain B.

The input dataset 402 belongs to a specified transaction registered in the transaction log 404 with a specific transaction identification 406. The dividing module divides the input dataset 402 into two input dataset pieces 502A and 502B. Two input dataset pieces 502A, 502B are used in this explanation for simplicity.

The address assignment module 600 on the blockchain first layer (Layer 1) assigns each input dataset piece 502A, 502B to be stored in a unique location in the blockchain second layer (Layer 2). That location's address, using the M and N values for the parity level and layer, is identified by the address stored in Layer 1.

In this example, the address assignment module 600 assigns an address of layer 2, sub-blockchain A for piece 1 and layer 2, sub-blockchain B for piece 2. In FIG. 7, 1A indicates that piece 1 is stored at blockchain A of Layer 2 and 2B indicates that piece 2 is stored at blockchain B of Layer 2. The three boxes in Layer 1 represent three different nodes 110. Each of the nodes 110 stores the blockchain. Layer 2 is also stored on each of the nodes 110.

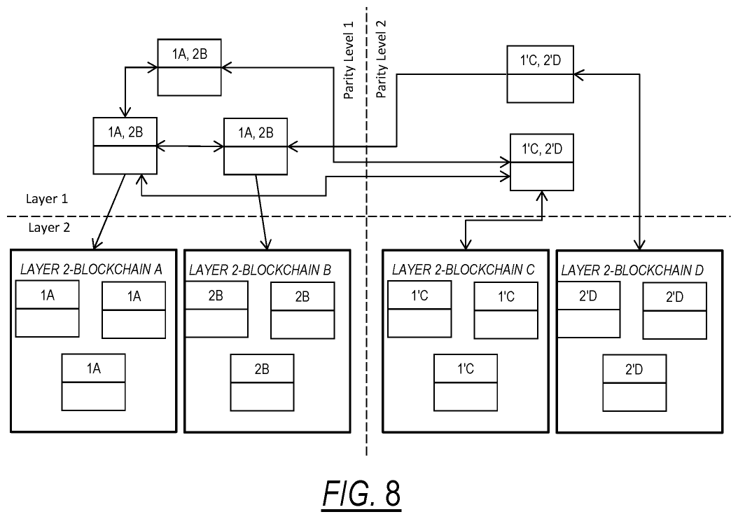

Referring to FIG. 8, an example of a two parity level (Parity Level 1 and Parity Level 2) blockchain, each with two layers (Layer 1, Layer 2) is shown. When a second input dataset is added, the dataset is divided into two input dataset pieces 1′ and 2′ by the dividing module 500. The address assignment module 600 on the second blockchain first layer (Parity Level 2 Layer 1) will assign each input dataset piece to be stored in a unique location in the second blockchain second layer (Parity Level 2 Layer 2). That location is identified by an address stored in the second blockchain first layer that specifies where each data piece is stored in the second blockchain second layer. In this example, the address assignment module 600 chooses an address of Parity Level 2, layer 2, sub-blockchain C for piece 1′ and Parity Level 2, Layer 2, sub-blockchain D for piece 2′.

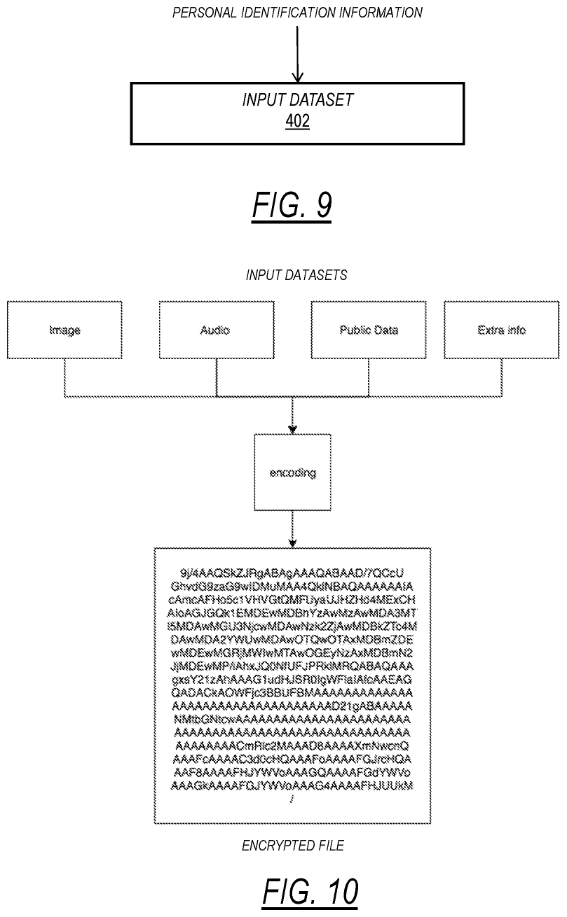

The input dataset 402 may take many different forms depending on the desired application. Referring to FIG. 9, in certain specific implementation examples, the input dataset 402 includes personal identification information 408 that is used to verify a person's identity. Such forms of personal identification information may include images of the person's face and/or unique features, fingerprints, voice recordings, a 3-D model of the person's face, outcome of voice analysis testing, and/or additional information obtained from public databases such as driver's license numbers, social security numbers, and the like. Additional personal identification information may be a stored pattern of the geolocation of the person, public social networking data such as social media profile links and relationships list, history of purchases used within the platform, and the like.

Use of the M-parity N-layer blockchain is advantageous for keeping personal identification information secure. In the case of an image of the person's face, for example, the input dataset would include the image in a digital image format such a jpg, tiff, bmp, or the like. The dividing module 500 would divide the image file into input dataset pieces 502, which are fragments of the image file. The address assignment module 600 would assign an address for storage of each of the fragments in the blockchain.

The input dataset 402 and input dataset pieces 502 may be encrypted for additional security. An example of an encryption algorithm that may be used in Base64 encoding for which the output is a string of text as illustrated in FIG. 10. Other possible, but non-limiting examples of encryption the Advanced Encryption Standard or similar encryption techniques. These are but a few possible examples of encryption algorithms that may be employed.

FIG. 10 illustrates an example of Base64 encryption of different types of input datasets 402. The encryption algorithm converts the input datasets 402 into an encrypted string of text that represents the input dataset 402.

The system 100 may be configured to require one or more types of permission to communicate with the blockchain. In one scenario called “parity permission,” different users may be permitted to access the same blockchain network Parity Level but not have access to all data on the blockchain. In another scenario called “layer permission” different users may be given access to retrieve a specified input dataset 402 or input dataset pieces 502.

The N-layer M-parity blockchain system has several security key formats for permitted data access. The first security key permits access between layers and the second security key permits access between parity levels.

For permission to access data between layers or “vertical permission,” the objective is to increase the level of security for a given input dataset 402. For this level of security, more than one person may access the input dataset 402, therefore, more than one security key is preferably required to retrieve the input dataset 402. This can be used to access data when two or more different entities need to be aware of the file contents and/or when they need to modify the contents.

For permission between parity levels or “horizontal permission,” the objective is to allow several entities to share the blockchain system resources, but without each entity having to access to all files in the blockchain system.

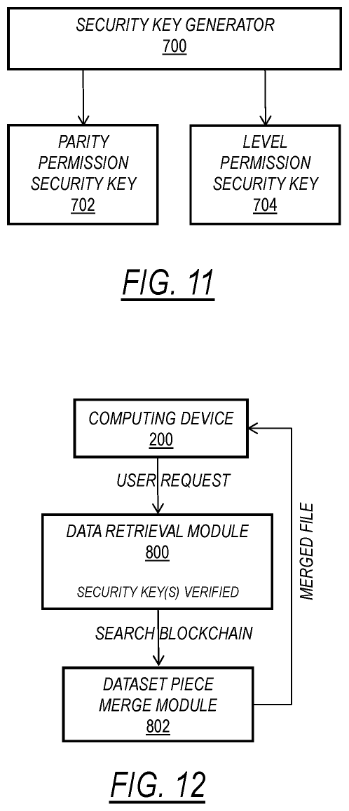

Referring to FIG. 11, the computer system 102 may execute a program module called a security key generator 700 that generates the different types of security keys based on a given user's permission level. For a user with parity permission, the security key generator 700 generates a parity permission security key 702. For a user with layer permission, the security key generator 700 generates a layer permission security key 704. For a user with both parity and layer permission, the security key generator 700 generates a parity permission security key 702 and a layer permission security key 704. In order to access the blockchain, each user inputs its security key(s) into its respective computing device 200, which is communicated to the computer system 102 via the network 112.

The security keys 702, 704 may have any number of forms. In a particular example, the security keys 702, 704 are cryptographic keys. In another example, the security keys 702, 704 are passwords. In yet another example, the security keys 702, 704 are a two factor authentication protocol such as a password combined with another type of input. There are many other possible examples of security keys 702, 704 that may be employed.

Having the input dataset pieces 502 of a given input dataset 402 spread across layers and parity levels has many advantages. Some, but not all, of the advantages include those now described.
Speed: Users may retrieve only pieces of a dataset or have the ability to retrieve several pieces at the same time in a parallel search.
Security: When different pieces of a dataset are spread across the layers and parity levels means that they are spread across different blockchains. Multiple blockchains need to be violated even with a small number of nodes to temper a full register.
Reliability: The redundancy provides the ability to reconstruct the first layer of the blockchain even with a small number of nodes. The sub-blockchains can detect changes in and restoring the blockchain first layer. The reason for that is that the first layer holds the address of the input dataset pieces. If a sub-layer detects a file change through an attack of 51% of power, the sub-layer blockchain can reconstruct the first layer, adding again the input data pieces with their respective addresses. Even without a large number of nodes, this functionality helps provide a reliable and secure blockchain.

Referring to FIG. 12, when a user wants to access data on the blockchain, the nodes 110 execute a data retrieval module 800 stored on the first layer that retrieves data from the blockchain based on a user request received by the computer system 102 from a user's computing device 200. The user request identifies the transaction in the transaction log 404 that the user wants to access. The data retrieval module 800 initially determines the security key(s) needed for accessing the data associated with the identified transaction and queries the user to enter the security key(s). Once the user inputs to the blockchain system what address at the main blockchain the user wants to access, the user sends the security key(s) 702,704 that it holds. The data retrieval module 800 then verifies the security key(s) 702,704. If it verifies the security key(s) 702,704, the data retrieval module 800. The data retrieval module 800 will search the blockchain for the first layer (Layer 1) that stores the addresses of the input dataset pieces 502 of the input dataset 402 associated with the transaction identified in the user request.

Once the data retrieval module 800 identifies the addresses of the input dataset pieces 502, a dataset piece merge model 802, obtains the input dataset pieces 502 from their respective blockchain addresses and combines the input dataset pieces 502 into a merged file that represents the input dataset 402. The merged file by may be substantially identical to the input data file 402 or it may be modified relative to the input data file 402, but still close enough to the input data file 402 to be recognizable by a user, computing device 200, or the computer system 102 as representing the input data file 402.

The merged file may be made available to the access computing device 200 in many different ways. In some examples, the merged file may be directly communicated to the access computing device 200. In other examples, the merged file may be made available to the access computing device 200 by communicating the results of analysis of the merged data file to the access computing device 200.

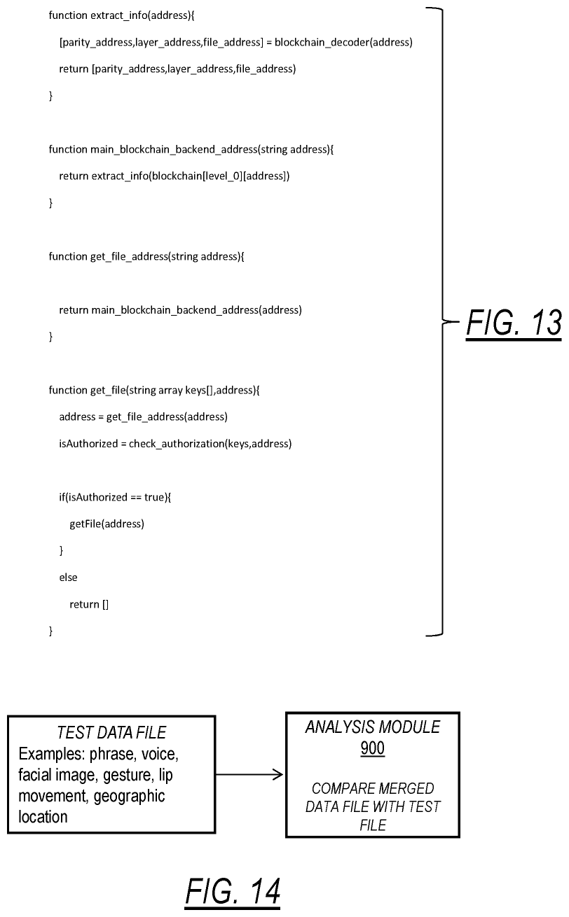

FIG. 13 provides an example of computing code that may be used to retrieve a merged file.

In certain example implementations of the blockchain system 100, the system 100 may be used to verify a person's identity using, as the input dataset, personal identification information. A particular example of such a use will now be described.

Referring to FIG. 14, in such an example, the merged file contains personal identification information and the computer system 102 and/or the nodes 110 execute an analysis module 900 that analyzes the merged file to compare the merged data file with a test data file.

The analysis module 900 may be capable of analyzing a phrase being said. In such a case, the personal identification information is a phrase. The phrase may be chosen between a random pool of words and phrases. The person may say the phrase into a microphone of the I/O interface 206 of a computing device 200. If the analysis module 900 verifies that the phrase the microphone detects is the phrase of the personal identification information, the analysis module 900 positively verifies the person's identity.

The analysis module 900 may be capable of analyzing voice qualities using a voice recognition algorithm and verify, by comparing with an utterance recorded as the personal identification information on the blockchain, whether the voice speaking into a microphone of the I/O interface 206 of a computing device 200 matches the personal identification information utterance. If the analysis module 900 verifies that the spoken utterance matches personal identification information utterance, the analysis module 900 positively verifies the person's identity.

The analysis module 900 may be capable of facial recognition by comparing a test data file of an image of a person's face, which may be taken by a camera of the I/O interface 206 of a computing device 200 with an image of the person's face stored as the personal identification information. The analysis module 900 may analyze whether the face test data file is static or moving and ask the person to perform a gesture such as turning the head to the left, tilting the head, blinking three times, or the like. If the gesture is completed, the analysis module 900 matches the person's face with the facial image personal identification information registered in the blockchain network. If the test data file facial image record matches, the analysis module 900 positively verifies the person's identity.

The analysis module 900 may be capable of analyzing the movement of the lips when the person is talking. If the movement pattern matches with the words of the phrase analyzed the analysis module 900 will register a match and the person's identity is verified. In this case, the test data file of the lip movement, which may be taken by a camera of the I/O interface 206 of a computing device 200.

The analysis module 900 may be capable analyzing whether the person's current geographic location matches the geographic travel pattern of the person at a given time. In such a case, the test data file is the person's current geographic location, which may be determined by a GPS or similar device on the person's computing device 200. For example, if the personal identification information shows that person usually commutes to work on Monday mornings in San Francisco, but the test data file shows the person attempting to have their identity verified in China, the analysis module 900 this would not verify the person's identity. In contrast, if the person's location pattern matches their current location, the analysis module 900 positively verifies the person's identity.

In some examples, each of the above-mentioned identity verification techniques may be employed. In other examples, it may be possible to employ some of the identity verification techniques and disable others. In a particular example, the preferred minimum number of identity verification techniques used to verify a person's identity is three.

The blockchain system used for identity verification may be a private blockchain. The private blockchain system is a network created and designed for the entity that desires to use it. The data corresponding to the entity's users will not be public and will be repeatedly validated by the nodes 110 of the network. If the identity verification aspect is being used to, for example, validate an attempt to use a credit card online, the blockchain system can be at the e-commerce store level, the bank level, the acquirer level, or the flag level.

If adopted at the e-commerce level, the blockchain system may be used to validate the e-commerce users and the blockchain system will store the e-commerce user data. If adopted at the flag level, the users of that flag will be on the network.

The nodes 110 may generate a new address for input dataset 402 and their respective input dataset pieces 502 when a new user is given permission to access the system 100. The data of the users may be registered as the transaction to that address.

When a person's identity is being analyzed, the system 100 may use the transactions sent to the user address to validate the data that is being checked. This means that the information of face, voice, and patterns, etc. that the system 100 analyzes will be at these records in the blockchain. If the data being collected matches with the data stored on the blockchain, the user is authenticated.

In a particular example, to add a new user into the system, it is useful to register the user's face and voice by storing a test data file of the user's face image and voice on the blockchain. The user may submit the facial image and voice sample from a computing device 200 to the nodes 110. The voice file may be a predefined phrase that the user is instructed to say. The nodes 110 will generate a digital identity for each user that will be used as the address of the blockchain. Once the address by the address assignment module 600, a transaction is sent to that address containing the image file and voice file that the system 100 uses to validate the person's identity as described above.

In certain examples the identity verification aspect is not executed on the user's computing device 200, preventing the user from being connected to the private blockchain network. Instead, the data collected is transferred to a server 104 running the identity verification aspects that will execute the analysis module 900. The server 104 also obtains the data off the blockchain system.

Although all the identity verification steps may be evaluated together in some case, the identity verification aspect may sometimes analyze them using separate servers 104, which means that the algorithm of every step can be improved or modified without affecting the others.

The system, method, and product are not limited to the details described in connection with the example embodiments. There are numerous variations and modification of the system, method, and product that may be made without departing from the scope of what is claimed.

That which is claimed is:

1. A computer-based method comprising:
(a) accessing, by a processor, a blockchain system shared by a plurality of computing nodes, the blockchain system including (i) a first blockchain subdivided into a first blockchain first layer and a first blockchain second layer and (ii) a second blockchain subdivided into a second blockchain first layer and a second blockchain second layer, the blockchain system storing an input dataset that is divided into a plurality of input dataset pieces that are stored on at least one of the first blockchain second layer and second blockchain second layer, the input dataset pieces being assigned an address reporting their respective location in the blockchain system;
(b) receiving a request from a computing device with a security key to access the input dataset;
(c) searching the blockchain system for the addresses of the input dataset pieces;
(d) merging the input dataset pieces into a merged file representative of the input dataset; and
(e) making available the merged file to the access computing device.

2. The method of claim 1, wherein the blockchain system executes a dividing module that divides the input dataset into the input dataset pieces, the dividing module being stored on at least one of the first blockchain first layer and second blockchain first layer.

3. The method of claim 1, wherein the blockchain system executes an address assignment module that assigns the address, the address assignment module being stored on at least one of the first blockchain first layer and second blockchain first layer.

4. The method of claim 1, wherein the first blockchain first layer and the second blockchain first layer store the respective addresses of the input dataset pieces.

5. The method of claim 1, wherein the input dataset includes personal identification information of a person and the method further comprises verifying the person's identity by receiving from a computing device a test data file and comparing the merged file to the test data file with an analysis module executed by the blockchain system.

6. The method of claim 5, wherein the personal identification information includes at least one of a facial image, a voice recording, and a geographic location of the person.

7. The computer-based method of claim 1, wherein input dataset pieces stored on the first blockchain are not stored on the second blockchain.

8. The computer-based method of claim 1, wherein the first blockchain second layer and the second blockchain second layer are configured, respectively, to restore the first blockchain first layer and the second blockchain first layer when data in the first blockchain first layer and/or the second blockchain first layer become corrupted.

9. The computer-based method of claim 1, wherein the security key is at least one of a parity permission security key that permits access to both the first blockchain and second blockchain and a layer permission security key that permits access to only one of the first blockchain and second blockchain.

10. A computer-based system comprising:
a computer readable memory storage medium storing a blockchain system and at least one processor in communication with the memory storage medium, the processor being configured to execute program instructions to:
(a) access, by a processor, a blockchain system shared by a plurality of computing nodes, the blockchain system including (i) a first blockchain subdivided into a first blockchain first layer and a first blockchain second layer and (ii) a second blockchain subdivided into a second blockchain first layer and a second blockchain second layer, the blockchain system storing an input dataset that is divided into a plurality of input dataset pieces that are stored on at least one of the first blockchain second layer and second blockchain second layer, the input dataset pieces being assigned an address reporting their respective location in the blockchain system;
(b) receive a request from a computing device with a security key to access the input dataset;
(c) search the blockchain system for the addresses of the input dataset pieces;
(d) merge the input dataset pieces into a merged dataset representative of the input dataset; and
(e) make available the merged file to the access computing device.

11. The computer-based system of claim 10, wherein the processor executes a dividing module that divides the input dataset into the input dataset pieces, the dividing module being stored on at least one of the first blockchain first layer and second blockchain first layer.

12. The computer-based system of claim 10, wherein the processor executes an address assignment module that assigns the address, the address assignment module being stored on at least one of the first blockchain first layer and second blockchain first layer.

13. The computer-based system of claim 10, wherein the first blockchain first layer and the second blockchain first layer store the respective addresses of the input dataset pieces.

14. The computer-based system of claim 10, wherein the input dataset includes personal identification information of a person and the processor is further configured to execute program instructions to verify the person's identity by receiving from a computing device a test data file and comparing the merged file to the test data file with an analysis module executed by the blockchain system.

15. The computer-based system of claim 14, wherein the personal identification information includes at least one of a facial image, a voice recording, and a geographic location of the person.

16. The computer-based system of claim 10, wherein input dataset pieces stored on the first blockchain are not stored on the second blockchain.

17. The computer-based system of claim 10, wherein the first blockchain second layer and the second blockchain second layer are configured, respectively, to restore the first blockchain first layer and the second blockchain first layer when data in the first blockchain first layer and/or the second blockchain first layer become corrupted.

18. The computer-based system of claim 10, wherein the security key is at least one of a parity permission security key that permits access to both the first blockchain and second blockchain and a layer permission security key that permits access to only one of the first blockchain and second blockchain.

19. A computer product comprising:
a computer readable memory storage medium storing a blockchain system and at least one processor in communication with the memory storage medium, the processor being configured to execute program instructions to:
(a) access, by a processor, a blockchain system shared by a plurality of computing nodes, the blockchain system including (i) a first blockchain subdivided into a first blockchain first layer and a first blockchain second layer and (ii) a second blockchain subdivided into a second blockchain first layer and a second blockchain second layer, the blockchain system storing an input dataset that is divided into a plurality of input dataset pieces that are stored on at least one of the first blockchain second layer and second blockchain second layer, the input dataset pieces being assigned an address reporting their respective location in the blockchain system;
(b) receive a request from a computing device with a security key to access the input dataset;
(c) search the blockchain system for the addresses of the input dataset pieces;
(d) merge the input dataset pieces into a merged dataset representative of the input dataset; and
(e) make available the merged file to the access computing device.

20. The computer-based system of claim 19, wherein the processor executes a dividing module that divides the input dataset into the input dataset pieces, the dividing module being stored on at least one of the first blockchain first layer and second blockchain first layer.

21. The computer product of claim 19, wherein the processor executes an address assignment module that assigns the address, the address assignment module being stored on at least one of the first blockchain first layer and second blockchain first layer.

22. The computer product of claim 19, wherein the first blockchain first layer and the second blockchain first layer store the respective addresses of the input dataset pieces.

23. The computer product of claim 19, wherein the input dataset includes personal identification information of a person and the processor is further configured to execute program instructions to verify the person's identity by receiving from a computing device a test data file and comparing the merged file to the test data file with an analysis module executed by the blockchain system.

24. The computer product of claim 23, wherein the personal identification information includes at least one of a facial image, a voice recording, and a geographic location of the person.

25. The computer product of claim 19, wherein input dataset pieces stored on the first blockchain are not stored on the second blockchain.

26. The computer product of claim 19, wherein the first blockchain second layer and the second blockchain second layer are configured, respectively, to restore the first blockchain first layer and the second blockchain first layer when data in the first blockchain first layer and/or the second blockchain first layer become corrupted.

27. The computer product of claim 19, wherein the security key is at least one of a parity permission security key that permits access to both the first blockchain and second blockchain and a layer permission security key that permits access to only one of the first blockchain and second blockchain.
